(19) United States
(12) Patent Application Publication
(10) Pub. No.: US 2020/0159610 A1
(43) Pub. Date: May 21, 2020

(54) METHOD FOR MAINTAINING A VIRTUAL MACHINE HOSTED ON A SERVER OF A HOST COMPUTER

(71) Applicant: BLADE, Paris (FR)

(72) Inventor: William Anger, Ivry-Sur-Seine (FR)

(21) Appl. No.: 16/685,752

(22) Filed: Nov. 15, 2019

(30) Foreign Application Priority Data
Nov. 16, 2018 (FR) 1860638

(51) Int. Cl. G06F 11/07; G06F 8/65; G06F 9/4401; G06K 9/62; G06N 20/00; G06F 9/455

(52) U.S. Cl. CPC G06F 11/0793; G06F 8/65; G06F 9/4406; G06F 2009/45595; G06N 20/00; G06F 9/45558; G06K 9/6267

(57) ABSTRACT

A method for maintaining a virtual machine hosted on a server of a host computer, the virtual machine including a graphics processing unit for preparing session images for display on a screen, the session images being produced by the virtual machine, comprises obtaining at least one session image prepared by the graphics processing unit, comparing the captured session image with at least one screen image representative of a non-functional state of the virtual machine, and determining the operating state of the virtual machine based on the result of the preceding comparison step.

### PRIORITY CLAIM

This application claims the benefit of the filing date of French Patent Application Serial No. 1860638, filed Nov. 16, 2018, for “METHOD FOR MAINTAINING A VIRTUAL MACHINE HOSTED ON A SERVER OF A HOST COMPUTER.”

### TECHNICAL FIELD

The present disclosure generally relates to a method for maintaining a virtual machine hosted on a server of a host computer.

The present disclosure finds a particular application in a computer architecture wherein a user computer session runs on a virtual machine and is distributed to a remote client which the computer session is associated with.

### BACKGROUND

Documents US2017228851 and FR3047576 describe a computer system configuration, wherein user interface devices (a display, a keyboard, . . . ) are separated from the processing part of the application. User interface devices (also collectively referred to as the “client”) are located near the user while the processing and storage components that form a host computer are located in a remote hosting location. User interface devices generally have access, at the host computer, to a dedicated virtual machine via a network (usually the Internet), with the virtual machine emulating the processing, storage and all other computing resources required for the user to operate a computer session, as if it was running locally. The host computer hosts the operation system and software applications used by the clients, which limits the processing resources on the client side.

It is common for the host computer to consist of a plurality of physical computer systems (servers), each hosting a plurality of virtual machines. Each virtual machine is connected to a client, and provides a dedicated virtual environment to emulate the functions of a physical personal computer, including processing graphical data, and provide user session display information on the client's screen. These session images are prepared and processed using a graphic card, which can be physical or virtual, that is assigned to the virtual machine at the time it is started. In the same way, the sound data produced during the execution of the user session is transferred to the client. The client has sufficient IT resources to receive the data flow and to display and/or transmit it. The client also exchanges information or instructions with the virtual machine, such as those generated by interface devices (a keyboard, a mouse, etc.). This information is called control data. Since session images are intended to be broadcast to the remote client, the servers which the virtual machines hosting these sessions run on are generally not connected to screens.

There may be situations wherein the virtual machine does not start properly, and for which the graphics card cannot be assigned to the virtual machine. In these situations, session images cannot be transferred to the remote client and cannot then be displayed on the remote client's screen. The user then has no means to determine the cause of the malfunction or to solve it. In the absence of screens linked to each user session on the host computer's site, these situations of non-operation are also difficult to detect by the site's maintenance teams.

It is possible to consider that in the event of a malfunction at the start of a virtual machine, a maintenance agent physically present on the site of the host computer could be alerted by the remote client or by the user of this remote client, and proceed, from the host computer, to detect and resolve this malfunction. However, this operation requires a reaction time on the maintenance agent's part, which is detrimental to the user's comfort.

More generally, when a malfunction occurs during the execution of the computer session on the virtual machine, it is embarrassing for the user to have to alert a maintenance agent and wait for his/her reaction before being able to benefit again from a functional virtual machine.

This disclosure aims to solve at least part of these problems, and proposes a virtual machine maintenance procedure that allows the host computer to detect and even solve certain malfunctions that may occur during the execution of the virtual machine, without requiring human intervention.

### BRIEF SUMMARY

In order to achieve this goal, the object of the present disclosure proposes a method for maintaining a virtual machine hosted on a server of a host computer, the virtual machine including a graphics processing unit for preparing session images to be displayed on a screen, the session images being produced [by] the virtual machine, the maintenance method including the following steps:
obtaining at least one session image prepared by the graphics processing unit;
comparing the captured session image with at least one screen image representative of a non-functional state of the virtual machine;
determining the operating state of the virtual machine according to the result of the previous comparison step.

By performing an automated analysis of a captured session image, a maintenance procedure in accordance with this description makes it possible to detect and even resolve, even when the virtual machine is disconnected from any display screen, certain malfunctions that may occur when starting the virtual machine 3 or during the execution of the computer session on this machine, without requiring human intervention.

According to other advantageous and non limiting characteristics of the present disclosure, taken either separately or in any technically feasible combination:
the graphics processing unit includes a virtual graphics card;
a non-functional state of the virtual machine is a boot failure of a virtual machine operating system;
a non-functional state of the virtual machine is an update of the virtual machine operating system;
a non-functional state of the virtual machine is a failure to update the virtual machine operating system;
the comparison step consists in detecting the presence of at least one predetermined characteristic pattern of the screen image in the session image;
the comparison and determination steps are implemented by a classification module configured by automatic learning;
the determination step also includes the preparation of a command to troubleshoot the virtual machine;
the maintenance method includes a repair step including sending the troubleshooting command to the virtual machine;
the troubleshooting command is a mouse click on a predetermined area of the screen, a character string, an instruction to restart the virtual machine;
the repair step is preceded with a step of backup of the virtual machine data on a backup server;
the steps are executed on a maintenance server distinct from the server hosting the virtual machine;
the steps are initiated by a remote client request, the image session being streamed to the remote client.

The subject matter of the present disclosure also proposes a computer program containing instructions suitable for carrying out the steps of the maintenance method according to one of the foregoing claims when the method is executed on a virtual maintenance machine or a maintenance server of the host computer.

### BRIEF DESCRIPTION OF THE DRAWINGS

Other characteristics and advantages of embodiments of the present disclosure will emerge from the detailed description of example embodiments which follows while referring to the appended drawings in which:

FIG. 1 represents a computer architecture wherein embodiments of the present disclosure can be implemented;

FIG. 2 represents the successive steps of one embodiment of a maintenance method according to the present disclosure;

FIGS. 3a to 3d represent screenshots corresponding to screen images representative of a non-functional state in accordance with the present disclosure.

### DETAILED DESCRIPTION

In the following description, detailed descriptions of known functions and elements, which could unnecessarily make the essential elements of embodiments of the present disclosure obscure, will be omitted.

### IT Architecture

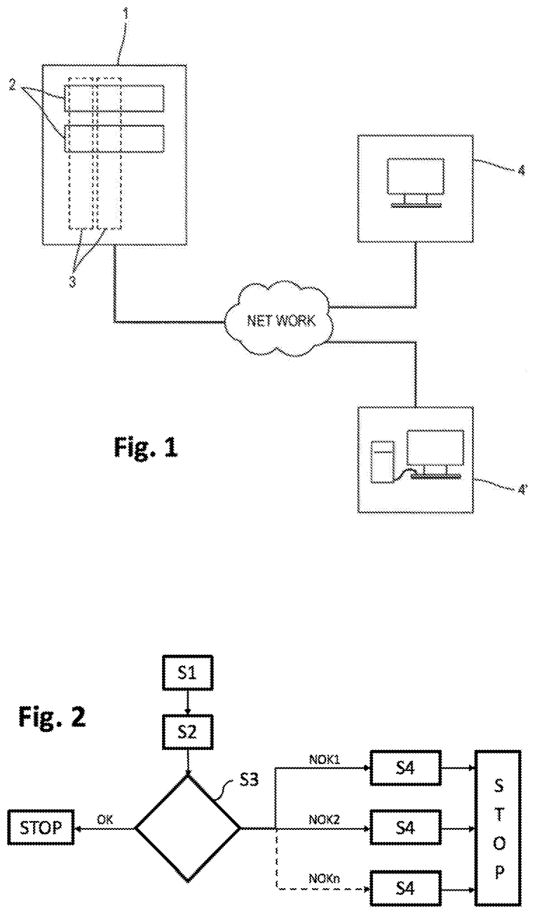

FIG. 1 shows a computer architecture making it possible to implement the maintenance method which will be the subject of a detailed description in the following description.

This architecture is formed here by a host computer 1 that has a plurality of servers 2. The servers 2 are made up of high-performance components (CPU, memory, storage disk, graphics and network cards, etc.) in order to form a particularly efficient hardware platform for running applications that may require significant processing capacities, such as video games.

As is well known, servers 2 can be configured to host one or more virtual machine(s) 3, along with its/their operating system and applications. Virtualization allows a plurality of virtual machines 3 to be hosted in each server 2 to provide a plurality of virtual environments totally isolated from each other. Each virtual environment has access to the server's hardware resources (CPU, memory, storage media, graphics card, etc.) to run a user computer session. Well-known virtualization technologies include Citrix XenServer, Microsoft Hyper-V, VMware ESXi, Oracle Virtual box, Quick Emulator under the GNU Open License (QEMU), etc.

Each of the virtual machines 3 in the host computer 1 can be dedicated to a specific user. The users interact with their dedicated virtual machines 3 from remote clients 4, 4′, each one being connected to the host computer 1 via a network such as the Internet. Since most, if not all, processing is done at the host computer 1, the remote clients 4, 4′ can remain very simple, and may include, for example, a simple terminal, a network connector and basic I/O devices (a keyboard, a mouse . . . ) as represented by the remote client 4 in FIG. 1. The remote client 4 can be a simplified computer device, such as a tablet, a smartphone. Alternatively, it may be a standard personal computer, with its own CPU, graphics card, peripherals, . . . as represented by the remote client 4′.

Each server 2 of the host computer 1 preferably hosts less than ten virtual machines 3 to provide sufficient IT resources, including hardware, to each virtual machine 3 to run high-performance applications with a sufficient level of service. Each virtual machine 3 is created at the time of the client's connection to host computer 1 and includes a virtual mainframe, virtual main memory, and all other necessary resources.

The virtual machine 3 has, or has access to, a graphics processing unit to prepare session display data. This graphics processing unit can include a simple hardware video card or a hardware graphics card associated with the virtual machine 3. It can also be a virtual video card or a virtual graphics card entirely emulated by the server 2's hardware resources (including its processing unit(s) and/or graphics card(s)), these resources being made available to the virtual machine 3 by the virtualization software layer (hypervisor) running on the server 2. This graphics processing unit can also mix hardware and virtual elements.

Whatever its, hardware or virtual, nature, the graphic processing unit associated with the virtual machine serves to prepare and provide display data for the computer session running on the virtual machine 3.

As described above, the user computer session runs on the host computer 1 and uses the processing capabilities of a graphics processing unit that prepares the session display data. This display data is repeatedly provided by the graphics processing unit to a buffer memory of this unit or associated with this unit. Display data can, for example, be prepared and provided every 4 to 35 milliseconds by the graphics processing unit.

Each virtual machine 3 emulates a high-performance virtual personal computer that is associated and controlled by a remote client 4, 4′. Each virtual machine 3 is therefore a user session, or is the equivalent thereof, and many of these user sessions can be run on the servers 2 of the host computer 1. The computing architecture can include a plurality of interconnected host computers 1, which may be located in geographically separate data centers.

Each user session is associated with a remote client 4, 4′. To display the images of the user session on the remote client 4, 4′ terminal associated therewith, the host computer 1 provides the remote client 4, 4′ with display information (including sound) and control information for the input/output devices installed at the remote site.

On the other hand, the remote clients 4, 4′ provide the host computer 1 with control information from the input/output devices on the remote site (a keyboard, a mouse), and possibly other forms of data such as display and sound information provided by a USB device or integrated into a camera and microphone of the remote client 4, 4′, or network devices, at the remote client, such as printers . . . .

In this description, “session information” refers to all information exchanged between a remote client 4, 4′ and the host computer 1.

On the host computer 1 side, a program to capture and broadcast session information runs, in the background, in each computer session. The capture and broadcast program implements operations for collecting the display, sound and control data prepared by the computer session, encoding this data to limit the use of network bandwidth and transmitting it to the remote client 4, 4′. The capture and broadcast program also receives and decodes the control data communicated by the remote client 4, 4′, uses it or provides it to the user session for conventional processing and exploitation.

The remote clients 4, 4′, on their side, are equipped with appropriate hardware and/or software resources to decode the information communicated by the capture and broadcasting program so that it can be used on the client side. These resources also allow the control data generated by the remote client 4, 4′ to be prepared and transmitted to the host computer 1. In addition to data from the remote client 4, 4′'s interface devices (a keyboard, a mouse, . . . ), control data may include additional information, such as information on the data rate received from the host computer 1, to characterize the quality of the link with that computer.

### Non-Functional State of a Virtual Machine

There are multiple causes that can make a virtual machine inoperative.

The non-functional state of the virtual machine 3 may correspond to a malfunction of the machine at the time of its start-up. This may be a failure to boot the operating system. Such a boot failure may be due to the installation of a new device driver on the server hosting the virtual machine, or an inability of the Basic Input Output System (BIOS) to detect the boot loader (in the frequently used Anglo-Saxon terminology) allowing the operating system to be launched.

The virtual machine may also be dysfunctional because an update of the operating system is in progress. During the entire time of this update, a computer session cannot be executed, the session images cannot be transmitted to the remote client 4, and the user remains confronted with a “black screen” for which he/she cannot know the cause.

Other non-functional states that may occur during startup can also be considered, such as hardware failures of the server 2 hosting the virtual machine.

In all these situations, the user session cannot be executed or displayed on the remote client 4, 4″ s screen, which complicates the characterization of the malfunction.

The non-functional state of the virtual machine 3 may also correspond to a malfunction of the virtual machine 3 during the execution of the user session. In these situations, the virtual machine 3 may have started, a user computer session is running on the virtual machine 3, but it is not running properly.

Thus, a failure to update the operating system can lead to the disappearance of all or part of the icons from the desktop environment. It is also possible that all these icons may appear, but the colors displayed may not be the correct ones. It is also possible that the names of the applications may have changed. It also happens that the language with which the office environment communicates with the user is completely or partially changed. These situations, for which it may still be possible to display the session on the remote client 4, 4′'s screen, do however cause inconveniences for the user that it would be desirable to be able to easily detect and correct.

A non-functional state of the virtual machine can sometimes be identified by simply viewing the image that appears on the remote client's screen or that would appear on a screen that is connected to the virtual machine. Such an image is referred to as a “screen image representative of a non-functional state” in this application. In some cases, this image can even be used to determine the cause of the malfunction or the troubleshooting command that would fix it.

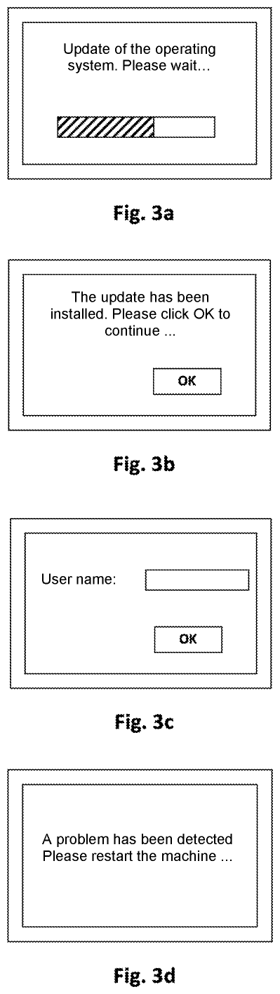

For example, a plurality of screenshots corresponding to screen images representative of a non-functional state have been reproduced in FIGS. 3a to 3d.

FIG. 3a shows a schematic screenshot of an operating system update. This state is dysfunctional in that it prevents the operating system from being launched before the update is completed. To be fixed, this state simply requires a delay until the end of the update.

FIG. 3b schematically shows a screenshot corresponding to the end of an update. This state is also dysfunctional in that it prevents the operating system from starting until the OK button is clicked. To be corrected, this state requires the cursor to be moved over the OK button and a mouse click to be made.

FIG. 3c schematically shows a screenshot of the end of an update requiring the entry of a user name and its validation. This state prevents the operating system from starting until the instructions have been executed. To be fixed, this state requires a character string to be instructed at the designated location, the cursor to be moved over the OK button and a mouse click to be made.

FIG. 3d schematically shows a screenshot inviting the user to restart the machine after a failure has been detected.

The drawings appended herein are given as examples and are not limiting to the present disclosure.

Screen images representing a non-functional state can be collected and stored to form a library of images or signatures of these images (generically referred to as “images” to simplify this description). This library can be supplemented with images as new dysfunctional situations are detected.

Each image in the library can be associated with a particular malfunction situation, and possibly with a troubleshooting command to resolve or attempt to resolve the malfunction. For example, the image in FIG. 3b is representative of a blocking situation wherein the virtual machine remains waiting for user validation, and the remedy is to click an “OK” button displayed on the screen. The troubleshooting command to resolve the malfunction in this case may correspond to moving the cursor to the coordinates corresponding to the location of the “OK” button and a mouse click. Troubleshooting commands can be prepared after image analysis and stored in the library, associating them respectively with the images which they apply to.

### Maintenance Method

The present disclosure seeks to take advantage of the computer environment just described to propose a maintenance method, for a virtual machine 3, that allows the host computer 1 to detect and solve certain malfunctions of the virtual machine 3. Without this characteristic forming any limitation of the present disclosure, this method can be implemented by a maintenance program running on a maintenance server of the host computer 1 separate from the server hosting the virtual machine 3. In this way, the maintenance of the virtual machine 3 is carried out using resources separate from the machine that may be dysfunctional, which guarantees its proper execution.

FIG. 2 schematically shows the steps of the maintenance method according to this description.

The maintenance method includes a step S1 of obtaining at least one session image prepared by the graphics processing unit of a virtual machine 3 hosted in the host computer. The virtual machine 3, which is the subject of the maintenance method, may have been designated by a maintenance agent, by the user of this machine himself/herself, or even randomly selected as part of a preventive maintenance campaign. The captured session image corresponds to the display data that is stored in a buffer memory of the graphics processing unit in the virtual machine.

This display data constituting the session image may be required by the maintenance program from the hypervisor of the server 2 hosting the virtual machine 3. The hypervisor can read the memory location wherein this data resides and return it to the maintenance program.

When the user session is running, the graphics processing unit can advantageously include a virtual graphics card and a physical graphics card. This configuration allows the user session to use the performance of the physical graphics card while allowing the maintenance program to request the display data that constitutes the session image from the hypervisor of the server 2 hosting the virtual machine 3.

Regardless of how the session image is obtained, the maintenance method then includes a step S2 of comparing the captured session image with the screen images representative of a non-functional state of the virtual machine. More specifically, in this step, the captured session image is compared with the library images. The general objective is to determine the extent to which the captured image actually corresponds to a library image, without requiring it to coincide “pixel to pixel.” In particular, image metrics can be applied and two images can be considered as corresponding if the distance between them is less than a specified threshold. Images can also be digitally processed to extract signatures, and the comparison can be made on these signatures.

The comparison can alternatively be made by a computer vision method called area of interest detection (commonly referred to as feature detection). This method consists in detecting areas of an image with remarkable local properties to calculate characteristics and then extract these characteristics. For example, there are invariant, recognizable and categorized patterns that are characteristic of a screen image that represents a non-functional state of the virtual machine. Known algorithms use this method, such as the SIFT algorithm (an acronym for “scale-invariant feature transform,” which can be translated as a transformation of visual characteristics invariant to scale) or the SURF algorithm (an acronym for “Speeded Up Robust Features,” which can be translated as accelerated robust characteristics).

This comparison step can be advantageously implemented by a classification module configured by automatic learning. This classification module can be, for example, a neural network. Preferably, this neural network may include a convolutional neural network.

At the end of this step, the result of the comparison is available, which can either be a correspondence of the captured session image with one of the images in the library, or the absence of such a correspondence.

The maintenance method then includes a step of determining S3 the operating state of the virtual machine according to the result of the comparison step. If the result of the comparison step is negative, that is, if the session image does not match any image in the library, the virtual machine is considered functional. Otherwise, the virtual machine is considered inoperative.

The determination step may include a binary distinction between a functional state and a non-functional state, regardless of the nature of the malfunction. In the event of a malfunction, the maintenance program may provide for an alert message to be sent to maintenance personnel to enable them to become aware of the existence of a malfunction and correct it if possible.

However, preferentially, the determination step may include a finer distinction depending on the nature of the non-functional states. Such an embodiment is illustrated in FIG. 2, which represents a functional state referenced “OK” and n non-functional states referenced NOK1 to NOKn. These different non-functional states can correspond to the different examples of non-functional states described above, and each corresponds to a representative image of a non-functional state. As shown in FIG. 2, this distinction offers the possibility of proposing repair treatments S4 adapted to each type of malfunction.

The determination step S3 then also includes the preparation of the troubleshooting command associated, in the library, with the image representing the non-functional state that corresponds to the captured session image. This step is followed by a repair step S4, which includes applying the troubleshooting command to the virtual machine 3.

Thus, as shown in FIG. 2, if the virtual machine 3 is considered to be in a functional state (OK) during the determination step S3, no troubleshooting commands are prepared, and the repair step S4 is not performed. In this situation, the maintenance program may stop (STOP).

As with the comparison step, the determination step can be implemented by a classification module configured by automatic learning, such as a neural network preferably comprising a convolutional neural network.

The non-functional state referenced NOK1 can lead to the preparation of a troubleshooting command corresponding to a simple delay, the repair step S4 simply consisting in implementing this delay. For example, such a state may correspond to an operating system update, shown in FIG. 3a, that only requires a waiting time before the operating system can be started, without any instructions being necessary.

The non-functional state may also correspond to a situation that would require the user to transmit an instruction using the interface devices (a mouse, a keyboard, etc.) at his/her disposal.

Thus, the troubleshooting command associated with a non-functional state referenced NOK2 can be a mouse click on a predetermined area of the screen. For example, the non-functional status may be the presence of an information or error window that requires one or more click(s), for example, in an “OK” box, as shown in FIG. 3b, to allow the computer session to run. This is the case, for example, at the end of an update, when a message may appear simply indicating the completion of the update or proposing to restart the virtual machine 3. Such a troubleshooting command can be applied to the virtual machine 3 by the maintenance program using the hypervisor, by instructing it to move the cursor to the coordinates corresponding to the location of the “OK” button and by emulating a mouse click. The cursor positioning coordinates and the click instruction then form the troubleshooting command stored in the image library, and associated, in that library, with the image shown in FIG. 3b.

Similarly, the troubleshooting command associated with a non-functional state referenced NOK3 can be the entry of a character string. For example, the non-functional state may correspond to the presence of an information or error window requiring the entry of a character string. This is particularly the case at the end of an update, where a message requiring the instruction of a password or specific information may appear, as shown in FIG. 3c. Such a troubleshooting command can be applied by the maintenance program using the hypervisor, emulating the functions of a keyboard of the virtual machine 3 during maintenance.

Another troubleshooting command, corresponding to another non-functional state, can be an instruction to restart the virtual machine 3. Such a troubleshooting command can be provided in the event of an unexpected shutdown of the operating system as a result of, for example, a bug, an operating error, a computer virus, a computer failure, a server 2 overheating or exceeding the capabilities of the virtual machine 3 which the operating system is running on. Such a situation is illustrated by the screen image of FIG. 3d.

At the end of the repair step S4, the maintenance program stops (STOP).

Alternatively, the program can return to step S1 of obtaining a session image in order to perform a new characterization of the operating state of the same virtual machine. All the steps already described can then be repeated until the virtual machine is in a functional state (OK), or repeated a number of times before alerting a maintenance agent if a functional state cannot be found.

The steps of the maintenance method described throughout this description can be performed automatically each time each virtual machine 3 is started on the host computer 1. This embodiment allows a systematic detection of malfunctions that may occur when the virtual machine 3 is launched.

Alternatively, to reduce the calculation load that can be imposed by a systematic execution of the maintenance program, the steps can be performed at the user's or a maintenance agent's request. The latter, noticing a problem when starting or running his/her computer session, can send an alert message to the host computer 1, which then triggers the steps presented. These steps can be triggered either automatically upon receipt of the alert message sent by the user or at the maintenance agents' request after processing the alert message.

The maintenance program can be run regularly and systematically for each virtual machine 3 hosted by the host computer or randomly over time and among all the hosted virtual machines. In other words, the maintenance procedure according to this description can be triggered at regular time intervals on a virtual machine, or randomly among the virtual machines hosted by the servers of the host computer 1. This embodiment, based on probabilities, allows a more or less close maintenance according to the triggering criteria of all the virtual machines. At the same time, it allows the calculation loads required to perform maintenance on all virtual machines to be predicted by setting trigger criteria.

Regardless of the embodiment implemented, by performing an automated analysis of a captured session image, a maintenance program that complies with this description makes it possible to detect and even solve certain malfunctions that may occur when starting the virtual machine 3 or during the execution of the computer session on this virtual machine 3, without requiring human intervention.

Of course, the present disclosure is not limited to the described embodiments and alternative solutions can be used without departing from the scope of the invention, as defined in the claims.

In particular, it is possible for the maintenance method to be implemented on the server 2 hosting the virtual machine 3 which the user computer session is running on. The maintenance method can even be implemented at the virtual machine 3 itself.

Nor is the present disclosure limited to the examples of operating states mentioned in this description. Other non-functional states, such as corrupted or missing data, corrupted hard disk partition tables, may be considered insofar as these non-functional states lead to a clearly identifiable session image.

The troubleshooting command may include a combination of the commands mentioned. For example, in the situation illustrated in FIG. 3c requiring the entry of a character string, the troubleshooting command may include moving the cursor to the coordinates of the text input field, then a mouse click, before entering the character string, moving the cursor to the coordinates of the “OK” button, and then applying a mouse click.

Similarly, other troubleshooting commands than those presented in this description may also be considered. In particular, although most of the commands described are emulation of user-defined commands (such as a mouse movement, a mouse click, a character string), a troubleshooting command can be provided consisting of one or more system commands.

Similarly, when the virtual machine 3 malfunction cannot be repaired without affecting data integrity, a reset of the virtual machine 3 can be performed. This reset, which results in the loss of all data recorded by the user on the virtual machine 3, often solves the most difficult malfunctions. This reset is often necessary when certain particularly sensitive data is corrupted.

In order to limit the damage caused to the user, a backup of the data on a backup server is sometimes possible. This step is often a prerequisite for resetting the virtual machine 3.

Nor is the present disclosure limited to images representing a non-functional state consisting of a single image. An image representative of a non-functional state may consist of a plurality of images. In this case, if the result of the comparison step is a correspondence of the session image with an image of the plurality of images, it is possible to repeat this comparison step with the previous and/or the next session image(s). In this situation, only the correspondence of the succession of session images with the plurality of images leads to characterize the non-functional state upon completion of the determination step.

This may be the case when the malfunction is not characterized by a single image, but by a succession of images. This is the case, for example, of a black screen, which is not characteristic of a malfunction on its own. On the other hand, a repeated succession of all-black and all-white screens may indicate a malfunction of the virtual machine 3. It is then not the image but the unwinding that reflects the malfunction.

Nor is the present disclosure limited to static content of the image library. Indeed, the user may notice a non-functional state of the virtual machine that is not foreseen in the maintenance program. In other words, the session image corresponding to this non-functional state is not part of the images representing a non-functional state of the virtual machine in the image library. It can then issue an alert signal, which can lead the maintenance program to take a screenshot of the user session and add this captured session image to the images in the image library. In other words, a maintenance method that complies with this description may include a step of receiving an alert signal from the remote client 4, 4′ by the host computer 1, a step of preparing a session image by the graphics processing unit, and a step of adding the session image to images representing a non-functional state of the virtual machine to the image library.

Similarly, the alert signal can be sent not by the user of the remote client 4, 4′ but by the host computer itself. This is the case, for example, when the routine in charge of executing the user session fails to execute the user session on the virtual machine, without the corresponding session image being an image representative of a non-functional state of the virtual machine present in the image library. In this case, the same steps can be implemented by the maintenance program.

What is claimed is:

1. A method for maintaining a virtual machine hosted on a server of a host computer, the virtual machine including a graphics processing unit for preparing session images for display on a screen, the session images being produced by the virtual machine, the maintenance method including the following steps:
obtaining at least one session image prepared by the graphics processing unit;
comparing the captured session image with at least one screen image representative of a non-functional state of the virtual machine; and
determining an operating state of the virtual machine according to the result of the previous comparison step.

2. The maintenance method according to claim 1, wherein the graphics processing unit includes a virtual graphics card.

3. The maintenance method according to claim 2, wherein a non-functional state of the virtual machine is a boot failure of an operating system of the virtual machine.

4. The maintenance method according to claim 3, wherein a non-functional state of the virtual machine is an update of the operating system of the virtual machine.

5. The maintenance method according to claim 4, wherein a non-functional state of the virtual machine is a failure to update the operating system of the virtual machine.

6. The maintenance method according to claim 5, wherein the comparison step consists in detecting the presence of at least one predetermined characteristic pattern of the at least one screen image in the at least one session image.

7. The maintenance method according to claim 6, wherein the comparing step and determining step are implemented by a classification module configured by automatic learning.

8. The maintenance method according to claim 7, wherein the determining step also includes preparation of a troubleshooting command for the virtual machine.

9. The maintenance method according to claim 8, further comprising a repair step comprising sending the troubleshooting command to the virtual machine.

10. The maintenance method according to claim 9, wherein the troubleshooting command is a mouse click on a predetermined area of the screen, a character string, a virtual machine restart instruction.

11. The maintenance method according to claim 9, wherein the repair step is preceded with a step of backup of virtual machine data on a backup server.

12. The maintenance method according to claim 1, wherein steps are executed on a maintenance server distinct from the server hosting the virtual machine.

13. The maintenance method according to claim 1, wherein steps are initiated by a remote client request, the at least one session image being streamed to the remote client.

14. A computer program containing commands intended to implement steps of the maintenance method according to claim 1, when the maintenance method is run on a virtual machine or a maintenance server for maintaining the host computer.

15. The maintenance method according to claim 1, wherein a non-functional state of the virtual machine is a boot failure of an operating system of the virtual machine.

16. The maintenance method according to claim 1, wherein a non-functional state of the virtual machine is an update of the operating system of the virtual machine.

17. The maintenance method according to claim 1, wherein a non-functional state of the virtual machine is a failure to update the operating system of the virtual machine.

18. The maintenance method according to claim 1, wherein the comparison step consists in detecting the presence of at least one predetermined characteristic pattern of the at least one screen image in the at least one session image.

19. The maintenance method according to claim 1, wherein the comparing step and determining step are implemented by a classification module configured by automatic learning.

20. The maintenance method according to claim 1, wherein the determining step also includes preparation of a troubleshooting command for the virtual machine.
